(19) United States
(12) Patent Application Publication
(10) Pub. No.: US 2017/0279213 A1
(43) Pub. Date: Sep. 28, 2017

(54) ELASTIC CONTACT SPRING AND ADAPTER USING THE CONTACT SPRING

(71) Applicant: AVIC JONHON OPTRONIC TECHNOLOGY CO., LTD, Luoyang, Henan (CN)

(72) Inventors: Guoqi ZHOU, Luoyang, Henan (CN); Lei ZHANG, Luoyang, Henan (CN); Xiaoguang ZHANG, Luoyang, Henan (CN)

(73) Assignee: AVIC JONHON OPTRONIC TECHNOLOGY CO., LTD, Luoyang, Henan (CN)

(21) Appl. No.: 15/507,164

(22) PCT Filed: Oct. 29, 2015
(86) PCT No.: PCT/CN2015/093253

§ 371 Date: Feb. 27, 2017

(30) Foreign Application Priority Data
Aug. 29, 2014 (CN) 201410434499.7

(51) Int. Cl. H01R 13/24

(52) U.S. Cl. CPC H01R 13/2421; H01R 13/2478; H01R 13/24

(57) ABSTRACT

Disclosed are an elastic contact spring and an adapter using the contact spring, The elastic contact spring comprises two contact parts and a connecting part located between the two contact parts, the two contact parts are arc-shaped and their peripheral surfaces form jacking surfaces in conductive contact with corresponding connectors, the two contact parts are in transition connection via the connecting part and their respective arc-shaped openings are respectively located on two sides of the connecting part. When the elastic contact spring is pressed in use, the arc-shaped contact parts and the connecting part of the elastic contact spring all form deformation parts to disperse the deformation stress, thereby prolonging the service life of the elastic contact spring, and tho elastic contact spring, which is only formed by simple arcs, does not have a special requirement for materials.

### FIELD OF THE INVENTION

The present invention relates to the field of connectors, and particularly, relates to an elastic contact spring and an adapter using the contact spring.

### BACKGROUND

Adapters are common ones among electrical connectors, and can be divided into plug-in adapters and terminating adapters according to different contact modes. The terminating adapter realizes electrical connection via a jacking contact between the corresponding ends of a contact element and an adapter connector.

The contact elements for the terminating adapters are mostly elastic contact elements, and at present, the common elastic contact elements for the terminating adapters are mainly in the following three shapes: 1, C shape, shown in FIG. 1; 2, spatial V shape, shown in FIGS. 2; and 3, helical spring shape, shown in FIG. 3.

Among the above three kinds of elastic contact elements, when the C-shaped and spatial V-shaped elastic contact elements are stressed during working, the bending points are single, so plastic deformation due to fatigue is easily produced and service lives are short; the requirement for materials for the helical spring-shaped elastic contact elements is relatively high, and the common copper material cannot provide enough elastic contact force, so special materials are needed and the manufacturing cost is relatively high; besides, relatively high loop inductance of helical springs is also unbeneficial to optimizing the performance of the adapters.

### SUMMARY

The aim of the present invention is to provide an elastic contact spring with low material requirement and long service life, which is used for a terminating adapter.

Meanwhile, the aim of the present invention is also to provide an adapter using the elastic contact spring.

In order to solve the above problems, the elastic contact spring of the present invention adopts the following technical solution: the elastic contact spring includes two contact parts in conductive contact with corresponding connectors and a connecting part located between the two contact parts, the two contact parts are arc-shaped and their peripheral surfaces form jacking surfaces in conductive contact with the corresponding connectors, the two contact parts are in transition connection via the connecting part and their respective arc-shaped openings are respectively located on two sides of the connecting part.

The contact parts and the connecting part form an S shape together.

The contact parts and the connecting part are made of plates or bands.

The adapter adopts the following technical solution: the adapter includes an insulating plate, the insulating plate is provided with penetrating mounting holes, elastic contact springs are fixedly assembled in the mounting holes, the elastic contact spring includes two contact parts in conductive contact with corresponding connectors and a connecting part located between the two contact parts, the two contact parts are arc-shaped and their peripheral surfaces form jacking surfaces in conductive contact with the corresponding connectors, the two contact parts are in transition connection via the connecting part and their respective arc-shaped openings are respectively located on two sides of the connecting part.

The contact parts and the connecting part of the elastic contact spring form an S shape together.

The contact parts and the connecting part of the elastic contact spring are made of plates or bands.

The two contact parts of the elastic contact spring are arc-shaped, the two contact parts are in transition connection via the connecting part, and their respective arc-shaped openings are respectively located on two sides of the connecting part. Thus, when the elastic contact spring is pressed in use, the arc-shaped contact parts and the connecting part all form deformation parts to disperse the deformation stress, thereby prolonging the service life of the elastic contact spring, and the elastic contact spring, which is only formed by simple arcs and the like, does not have a special requirement for materials.

### BRIEF DESCRIPTION OF THE DRAWINGS

FIG. 1 is a structural schematic diagram of a C-shaped elastic contact spring;

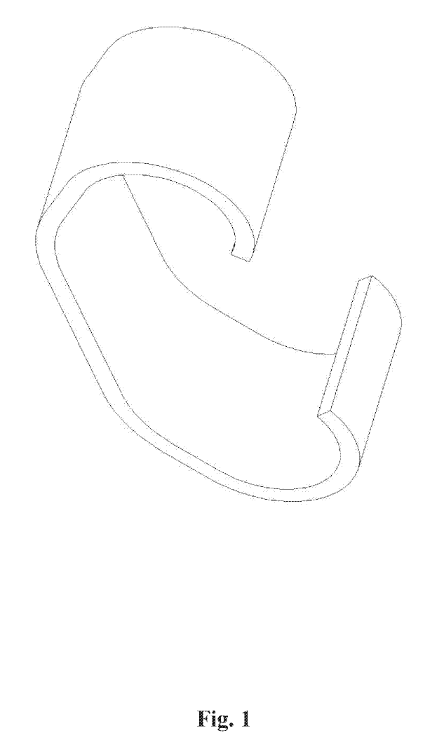

FIG. 2 is a structural schematic diagram of a spatial V-shaped elastic contact spring;

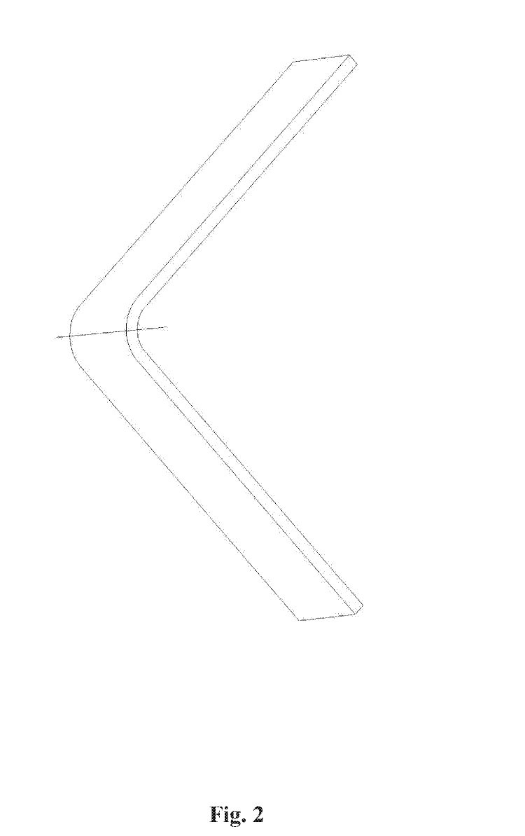

FIG. 3 is a structural schematic diagram of a helical spring-shaped elastic contact swing;

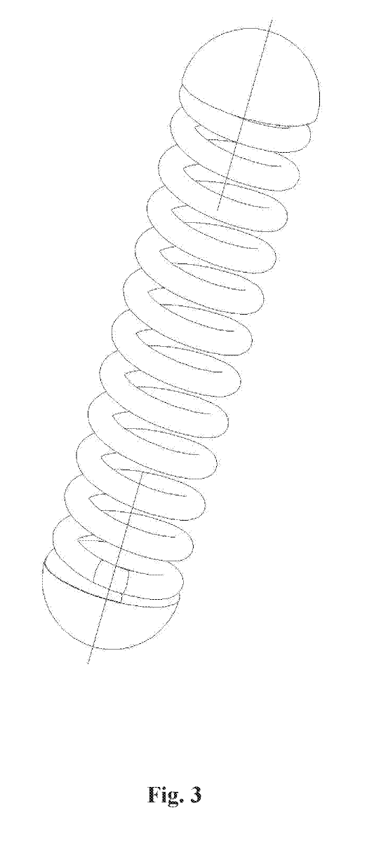

FIG. 4 is a structural schematic diagram of an embodiment of an elastic contact swing;

FIG. 5 is a structural schematic diagram of an embodiment of an adapter;

FIG. 6 is a matching schematic diagram of an insulator of the adapter and elastic contact springs.

### DETAILED DESCRIPTION OF THE EMBODIMENTS

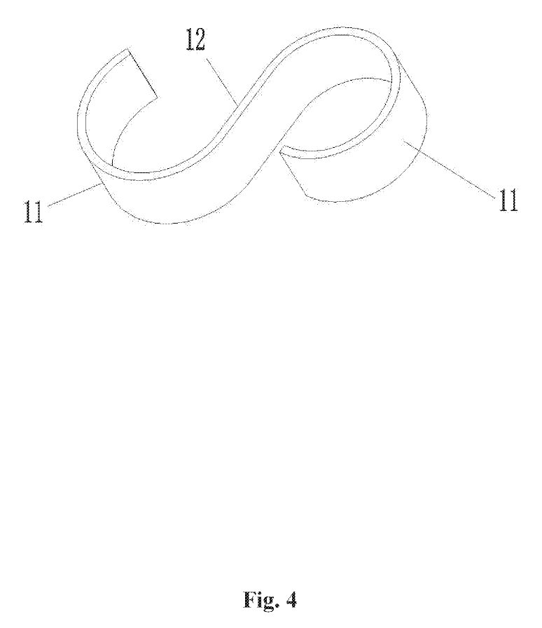

An embodiment of an elastic contact spring is shown in FIG. 4, and the elastic contact spring includes two contact parts 11 in conductive contact with corresponding connectors and a connecting part 12 located between the two contact parts.

The two contact parts 11 are arc-shaped and their peripheral surfaces form jacking surfaces in conductive contact with the corresponding connectors, in this embodiment, the contact parts 11 are specifically C-shaped, the jacking surfaces are located at arc tops, the contact parts 11 are in transition connection via the connecting part 12 and the respective arc-shaped openings are respectively located on two sides of the connecting part. The two contact parts are connected by the connecting part and then form an S shape together with the connecting part. The contact parts and the connecting part are made of plates or bands.

In other embodiments of the elastic contact spring, the contact parts and the connecting part can also be made of rods.

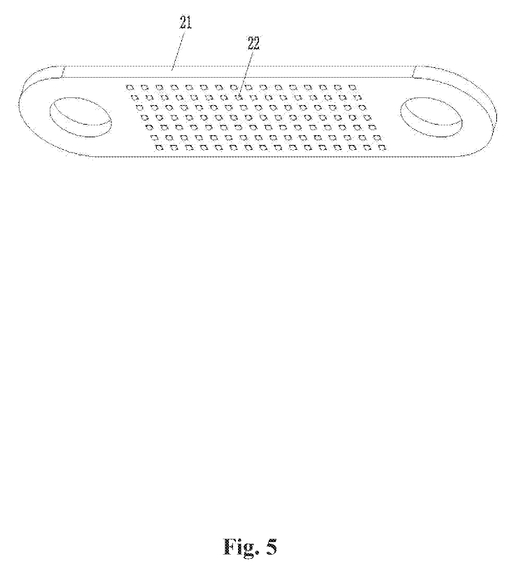

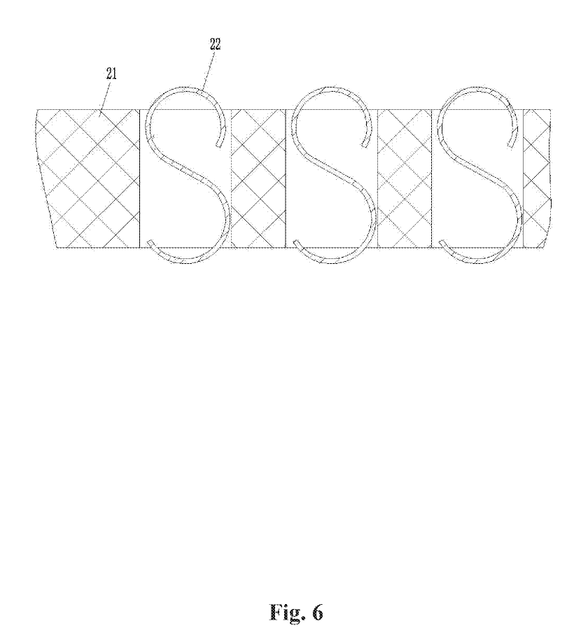

An embodiment of an adapter is shown in FIGS. 5-6, the adapter includes an insulating plate 21 and elastic contact springs 22, the insulating plate 21 is provided with mounting holes, the elastic contact springs 22 are fixedly assembled in the corresponding mounting holes, and in this embodiment, the structure of the elastic contact springs 22 is the same as that of the embodiment of the above-mentioned elastic contact spring and is thus not redundantly described herein.

1. An elastic contact spring, including two contact parts in conductive contact with corresponding connectors and a connecting part located between the two contact parts, wherein the two contact parts are arc-shaped and their peripheral surfaces form jacking surfaces in conductive contact with the corresponding connectors, the two contact parts are in transition connection via the connecting part and their respective arc-shaped openings are respectively located on two sides of the connecting part.

2. The elastic contact spring as set forth in claim 1, wherein the contact parts and the connecting part form an S shape together.

3. The elastic contact spring as set forth in claim 1, wherein the contact parts and the connecting part are made of plates or bands.

4. An adapter, including an insulating plate, the insulating plate is provided with penetrating mounting holes, elastic contact springs are fixedly assembled in the mounting holes, the elastic contact spring includes two contact parts in conductive contact with the two contact parts are arc-shaped and their peripheral surfaces form jacking surfaces in conductive contact with the corresponding connectors, the two contact parts are in transition connection via the connecting part and their respective arc-shaped openings are respectively located on two sides of the connecting part.

5. The adapter as set form in claim 4, wherein the contact parts and the connecting part of the elastic contact spring form an S shape together.

6. The adapter as set forth in claim 4, wherein the contact parts and the connecting part of the elastic contact spring are made of plates or bands.

7. The elastic contact spring as set forth in claim 2, wherein the contact parts and the connecting part are made of plates or bands.

8. The adapter as set forth in claim 5, wherein the contact parts and the connecting part of the elastic contact spring are made of plates or bands.
